(19) United States
(12) Patent Application Publication
(10) Pub. No.: US 2016/0217910 A1
(43) Pub. Date: Jul. 28, 2016

(54) INDUCTOR AND METHOD OF MANUFACTURING THE SAME

(71) Applicant: SAMSUNG ELECTRO-MECHANICS CO., LTD., Suwon-Si (KR)

(72) Inventor: Myeong Gi KIM, Suwon-Si (KR)

(21) Appl. No.: 14/970,413

(22) Filed: Dec. 15, 2015

(30) Foreign Application Priority Data
Jan. 27, 2015 (KR) 10-2015-0012968

(51) Int. Cl. H01F 27/28; H01F 41/02; H01F 27/29

(52) U.S. Cl. CPC H01F 27/2804; H01F 27/29; H01F 41/02; H01F 2027/2809

(57) ABSTRACT

An inductor includes an internal electrode including a coil pattern containing graphene and a sheet having a surface on which the internal electrode is disposed.

### CROSS-REFERENCE TO RELATED APPLICATION

This application claims the benefit of priority to Korean Patent Application No. 10-2015-0012968, filed on Jan. 27, 2015 with the Korean Intellectual Property Office, the entirety of which is incorporated herein by reference.

### BACKGROUND

The present disclosure relates to an inductor and a method of manufacturing the same.

An inductor, a device which suppresses rapid change in current by inducing a voltage proportional to an amount of change in the current, is used as a component for removing noise or forming an LC resonance circuit, or the like.

An inductor may be classified depending on its structure. A wire-wound inductor has a coil shape formed by winding a coil around a ferrite core. A multilayer type inductor is formed by printing an internal electrode pattern on a sheet formed of a magnetic or dielectric material, or the like, and stacking the plurality of sheets on which the internal electrode pattern is formed. A thin film type inductor is formed by printing a coil pattern on a substrate and forming electrodes on opposite ends of the substrate.

### SUMMARY

An exemplary embodiment of the present disclosure provides an inductor including an internal electrode including a coil pattern containing graphene, and a method of manufacturing the same.

According to an exemplary embodiment of the present disclosure, an inductor includes an internal electrode including a coil pattern containing graphene, and a sheet having a surface on which the internal electrode is disposed.

The sheet supporting the inductor may be provided as a polymer composite containing a non-magnetic material and a polymer material or a polymer composite containing a magnetic material and a polymer material.

A plurality of internal electrodes and a plurality of sheets may be disposed to be alternately stacked with each other.

The inductor may further comprise a via penetrating through the sheet.

The inductor may further comprise external electrodes provided on opposite end portions of the inductor to be electrically connected to opposite ends of the internal electrode.

According to an exemplary embodiment of the present disclosure, a method of manufacturing an inductor includes forming an internal electrode containing graphene by injecting electrodes in a graphene-mixed solution and applying power to the electrodes to move electrically-charged graphene to the electrodes on which the coil pattern has been provided.

The step of forming the graphene-mixed solution may comprise dispersing graphene oxide in the aqueous solution.

The method may further comprise a step of reacting the graphene with an amine group to modify the graphene.

The method may further comprise steps of preparing a sheet and transferring the internal electrode on the sheet.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a view illustrating an inductor according to an exemplary embodiment in the present disclosure;

FIG. 2 is a view illustrating an inductor according to another exemplary embodiment in the present disclosure;

FIGS. 3 through 8 are cross-sectional views illustrating a method of manufacturing the inductor according to the exemplary embodiment in the present disclosure; and

FIG. 9 is a flow chart illustrating the method of manufacturing the inductor according to the exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

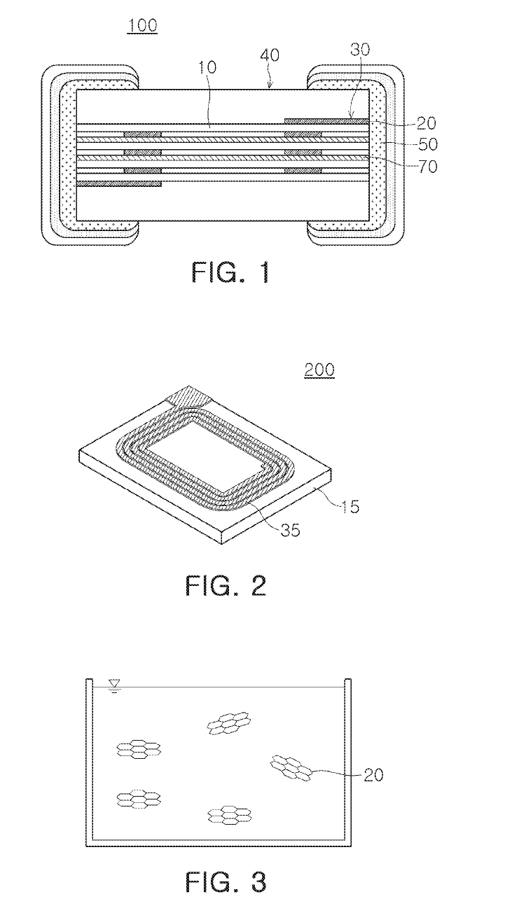

FIG. 1 is a view illustrating an inductor 100 according to an exemplary embodiment in the present disclosure.

The inductor 100 according to the exemplary embodiment may be provided as a multilayer type inductor.

The inductor 100 may include internal electrodes 30 formed of coil patterns containing graphene 20 and sheets 10 having one surface on which the internal electrodes 30 are formed.

The internal electrodes 30 may be formed on one surface of the sheets 10, and the sheets 10 may support the internal electrodes 30.

The sheets 10 may include a polymer composite and the polymer composite may contain a magnetic material and a polymer material.

The polymer composite may be formed to contain a non-magnetic material and a polymer material. In addition, the sheets 10 may be configured to include a polymer material only.

Here, as the polymer material, polyethylene (PE) or polyethylene terephthalate (PET) may be used, and a transparent multilayer type inductor may be manufactured by using PE or PET as the sheet material.

For the sheets 10 containing the non-magnetic material, a plurality of non-magnetic ceramic insulation sheets may be used. For the sheets 10 containing the magnetic material, ferrite magnetic sheets or the like may be used.

In detail, each of the sheets 10 may be a magnetic sheet formed of an Ni—Zn—Cu ferrite.

The Ni—Zn—Cu ferrite may be ferrite selectively containing Fe₂O₃, NiO, ZnO, CuO, and the like.

In order to obtain high precision and high Q characteristics in accordance with a relatively high frequency of the multilayer type inductor 100, the sheets 10 may be formed using non-magnetic ceramic insulation sheets containing a non-magnetic material.

A sheet of a high-frequency inductor may be composed of a non-magnetic material and a polymer material or composed solely of a polymer material.

In the inductor 100 according to an exemplary embodiment in the present disclosure, the internal electrodes 30 containing the graphene 20 may be formed on the sheets 10.

The graphene 20 is a thin film formed of carbon atoms having a thickness of a single atom. It is a nano-material capable of being obtained by detaching a single layer from several layers of graphite.

The graphene 20 has electrical conductivity at least 100 times higher than that of copper, and may move electrons at least 100 times faster than single crystalline silicon, which is mainly used in semiconductors.

In addition, the graphene 20 has strength at least 200 times stronger than that of steel and has high thermal conductivity. Furthermore, the graphene 20 has high tensile strength, and thus even in a case in which the graphene 20 is stretched or bent, the graphene 20 does not lose electrical properties thereof.

Since the graphene 20 has a high degree of strength and does not lose the electrical properties thereof when the graphene 20 is stretched or bent, the graphene 20 may be used as a material in flexible displays, electronic paper, wearable electronic devices, or the like.

When the graphene 20 is used as an internal electrode of an inductor, an inductor formed as a micro-scale component may be manufactured. In this way, an inductor suitable for being applied to flexible displays or wearable electronic devices used under various environmental conditions may be manufactured due to the flexibility of the graphene 20.

The internal electrodes 30 may contain the graphene 20 and may form a coil so that electrical resistance is changed depending on an electric field applied thereto. Alternatively, the internal electrodes 30 may form various patterns so that inductance may be formed by the graphene 20.

In addition, the internal electrodes 30 may be formed on one surface of the sheets 10 in a loop shape of which one portion is open, and the sheets on which the internal electrodes 30 are formed may be stacked, and thus the internal electrodes 30 may form a spiral coil.

The coil patterns of the internal electrodes 30 may be formed up to distal ends of the sheets to be connected to the external electrodes 50.

The inductor 100 may further include vias 32 penetrating through the sheets 10 so that the internal electrodes 30 formed on the sheets 10 may be electrically connected to each other.

In the inductor 100, according to an exemplary embodiment, a thickness of the internal electrodes 30 and the number of stacked internal electrodes may be variously designed depending on electrical properties such as inductance.

The inductor 100 may include the body formed by stacking a plurality of sheets 10 and internal electrodes 30, and may include the sheets 10 on which the internal electrodes 30 are formed and cover layers formed of the same material as that of the sheets 10 on upper and lower portions of the sheets 10.

The cover layers formed in the body 40 may protect the internal electrodes 30 from physical and chemical stress.

The body 40 may include gap layers 70 formed of a magnetic material and interposed between the sheets in order to decrease a change in inductance with respect to an external current.

The gap layers 70 may partition the body 40 into a plurality of regions and may be provided in plural. Thus, a magnetic field generated in each of the partitioned regions may be blocked by the gap layer 70, and flows of magnetic fields between the regions may be significantly decreased.

The external electrodes 50 may be formed on opposite end portions of the inductor to be electrically connected to ends of the internal electrodes 30.

The external electrodes 50 may be provided outside of the body 40, and thus the multilayer type inductor 100 may be electrically connected to external terminals.

On the external electrodes 50, metal layers and plating layers formed on the metal layers may be further formed, and the plating layers may be formed of nickel (Ni) or tin (Sn).

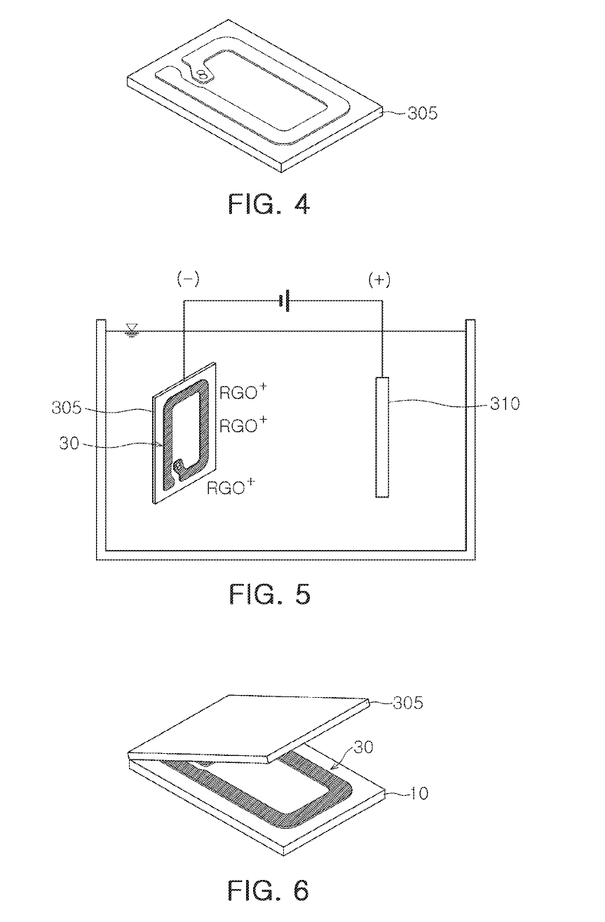

FIG. 2 is a view illustrating an inductor 200 according to another exemplary embodiment.

The inductor according to another exemplary embodiment may be a thin film type inductor 200.

Referring to FIG. 2, the thin film type inductor 200 may include coil shaped internal electrodes 35 formed by depositing graphene 20 on a sheet 15.

The thin film type inductor 200 may include magnetic layers containing a magnetic material on and below the sheet 15, and thus the internal electrodes 35 may be disposed between the magnetic layers.

Since the internal electrodes 35 are disposed between the magnetic layers, inductance may be further increased.

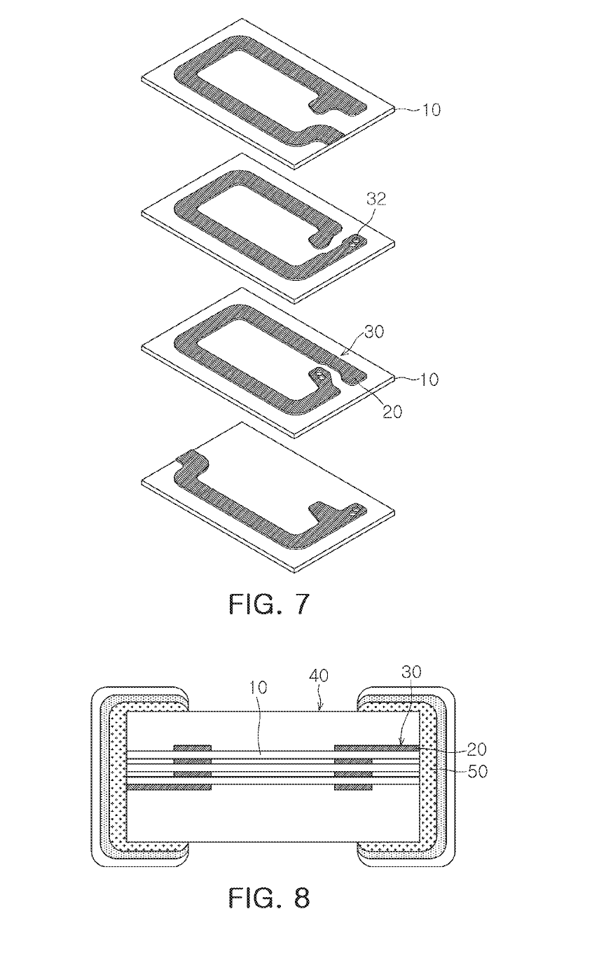

FIGS. 3 through 8 are cross-sectional views illustrating a method of manufacturing an inductor according to an exemplary embodiment.

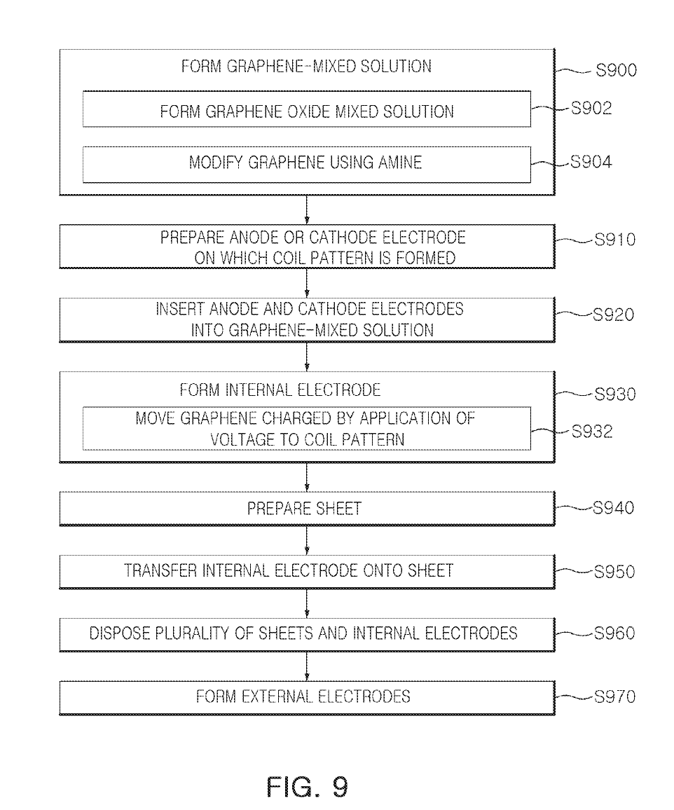

FIG. 9 is a flow chart illustrating a method of manufacturing an inductor according to an exemplary embodiment.

Hereinafter, a method of manufacturing the multilayer type inductor 100 will be mainly described.

The method of manufacturing an inductor 100 according to an exemplary embodiment is a process using electrophoresis in which, when power is supplied to a anode electrode 305 and a cathode electrode 310 using an external power supply device, electrically charged graphene moves toward the anode electrode 305 or cathode electrode 310.

Describing a method of manufacturing an inductor with reference to FIGS. 3 through 9, the method of manufacturing an inductor 100 may include steps of: forming a graphene-mixed solution by dispersing graphene 20 in an aqueous solution (S900); preparing anode and cathode electrodes 305 and 310 on which a coil pattern is formed (S910); inserting the anode and cathode electrodes 305 and 310 into the graphene-mixed solution (S920);

and forming internal electrodes 30 in which the graphene 20 is contained in the coil pattern thereof by applying power to the anode electrode 305 and the cathode electrode 310 (S930).

The step of forming the graphene-mixed solution by dispersing the graphene 20 in the aqueous solution (S900) may include dispersing graphene oxide in the aqueous solution (S902); and reacting the graphene 20 with an amine group to modify the graphene (S904).

The step of forming the graphene-mixed solution by dispersing the graphene 20 in the aqueous solution (S900) may include preparing graphene oxide (GO) or reduced graphene oxide from oxidized graphite to form a graphene oxide mixed solution or a reduced graphene oxide mixed solution.

A preparation method of graphene oxide (GO) or reduced graphene oxide may be Hummer's Method.

The step of reacting the graphene 20 with the amine group to modify the graphene (S904) may include reacting the graphene with amine to change a property of the graphene 20 from negatively-charged particles to positively-charged particles.

When the graphene 20 is modified into positively-charged particles, costs thereof may be reduced by forming an internal electrode 30 on the cathode electrode 310 using copper as the cathode electrode 310, as compared to a casein which the internal electrode 30 is formed using platinum as the anode electrode 305.

Then, the steps of preparing the anode and cathode electrodes 305 and 310 on which the coil pattern is formed (S910), inserting the anode and cathode electrodes 305 and 310 into the graphene-mixed solution (S920), and forming the internal electrodes 30 (S930) may be performed.

The step of forming the internal electrode 30 (S930) may include applying power to the cathode electrode 310 and charging the graphene 20 to thereby move the charged graphene 20 to the coil pattern so as to allow the graphene 20 to be included in the coil pattern (S932).

Next, a step of preparing a sheet (S940) and transferring the internal electrode 30 to the sheet 10 (S950) may be performed.

The step of preparing the sheet (S940) may include preparing a sheet containing a polymer composite, wherein the polymer composite may be composed of a non-magnetic material and a polymer material or composed solely of a polymer material.

The step of preparing the sheet (S940) may include preparing a plurality of non-magnetic insulation sheets or ferrite magnetic sheets.

The step of transferring the internal electrode 30 onto the sheet 10 (S950), which is transferring the internal electrode 30 formed on the anode electrode 305 or the cathode electrode 310 onto the sheet 10, may include various processing methods for maintaining a clean surface of the graphene 20 formed on the internal electrode 30 or maintaining a shape thereof.

The method of manufacturing an inductor may further include stacking a plurality of internal electrodes 30 and sheets 10 (S960) and forming external electrodes on opposite end portions of the sheets 10 to be electrically connected to ends of the internal electrodes 30 (S970).

Although the method of manufacturing a multilayer type inductor 100 is mainly described in FIGS. 3 through 9 as the method of manufacturing an inductor 100, the thin film type inductor 200 may also be manufactured by a manufacturing method similar to the method of manufacturing a multilayer type inductor 100.

In the method of manufacturing a thin film type inductor 200, a series of processes from the dispersion of the graphene in the aqueous solution to form the graphene-mixed solution (S900) to the transfer of the internal electrode on the sheet (S950) may be performed, similarly to the method of manufacturing a multilayer type inductor 100.

In the method of manufacturing an inductor using electrophoresis, the internal electrodes may be manufactured using graphene by a simple manufacturing process, and mass production may be performed by repeating the step of applying power to the electrode.

A pattern may be formed on a copper electrode by additionally modifying the graphene oxide or reduced graphene oxide using amine, and thus the cost may be further reduced.

In addition, various inductors such as thin film type inductors, and the like, as well as multilayer type inductors may be designed in the method of manufacturing an inductor using electrophoresis.

According to the exemplary embodiment, the internal electrode is formed using the graphene having a nano-scale size, and thus an ultra-small and ultra-light graphene inductor may be manufactured. Flexible electronic devices resistant to external impacts may be manufactured using the high tensile strength and flexibility of the graphene.

According to the exemplary embodiment, an ultra-small and ultra-light inductor maybe manufactured, and the ultra-small and ultra-light inductor may be advantageously implemented in wearable electronic devices.

According to the exemplary embodiment, a transparent polymer material such as polyethylene may be used as a material of the sheet of the inductor. Therefore, the inductor according to the exemplary embodiment may be implemented in wearable electronic devices requiring optical transmittance.

Further, according to the exemplary embodiment, the inductor may be used in wearable devices and electronic devices resistant to various external environments because of the high strength and electric conductivity of the graphene.

As set forth above, according to exemplary embodiments in the present disclosure, an ultra-small and ultra-light graphene inductor may be manufactured by forming an internal electrode using nano-scaled graphene. Thus, flexible electronic devices resistant to external impacts may be manufactured using the relatively high tensile strength and flexibility of the graphene.

While exemplary embodiments have been shown and described above, it will be apparent to those skilled in the art that modifications and variations could be made without departing from the scope of the present invention as defined by the appended claims.

What is claimed is:

1. An inductor comprising:
an internal electrode including a coil pattern containing graphene; and
a sheet having a surface on which the internal electrode is disposed.

2. The inductor of claim 1, wherein a plurality of internal electrodes and a plurality of sheets are disposed to be alternately stacked with each other.

3. The inductor of claim 1, further comprising a via penetrating through the sheet.

4. The inductor of claim 2, further comprising external electrodes provided on opposite end portions of the inductor to be electrically connected to opposite ends of the internal electrode.

5. The inductor of claim 1, wherein the sheets contain a polymer composite, and
the polymer composite contains a non-magnetic material and a polymer material.

6. The inductor of claim 1, wherein the sheets contain a polymer material or a polymer composite, and
the polymer composite contains a magnetic material and a polymer material.

7. The inductor of claim 6, wherein the polymer material is polyethylene (PE) or polyethylene terephthalate (PET).

8. The inductor of claim 1, further comprising a gap layer made of a magnetic material.

9. A method of manufacturing an inductor, the method comprising steps of:
forming a graphene-mixed solution by dispersing graphene in an aqueous solution;
preparing anode and cathode electrodes on which a coil pattern is provided;
inserting the anode and cathode electrodes into the graphene-mixed solution; and
forming an internal electrode in which the graphene is contained in the coil pattern of the internal electrode by applying power to the anode and cathode electrodes.

10. The method of claim 9, wherein the step of forming the graphene-mixed solution comprises dispersing graphene oxide in the aqueous solution.

11. The method of claim 9, further comprising a step of reacting the graphene with an amine group to modify the graphene.

12. The method of claim 9, further comprising steps of:
preparing a sheet; and
transferring the internal electrode on the sheet.

13. The method of claim 12, wherein a plurality of the internal electrodes and a plurality of the sheets are disposed to be alternately stacked with each other.

14. The method of claim 13, further comprising a step of providing external electrodes on opposite end portions of the sheets to be electrically connected to ends of the internal electrodes.
